(19) United States
(12) Patent Application Publication
(10) Pub. No.: US 2018/0151911 A1
(43) Pub. Date: May 31, 2018

(54) ELECTROLYTE FOR AN ALKALI-SULFUR BATTERY, ALKALI-SULFUR BATTERY CONTAINING THE ELECTROLYTE AND USES OF THE COMPONENTS OF SAME

(71) Applicant: FRAUNHOFER-GESELLSCHAFT ZUR FÖRDERUNG DER ANGEWANDTEN FORSCHUNG E.V., München (DE)

(72) Inventors: Sören THIEME, Dresden (DE); Holger ALTHUES, Dresden (DE); Stefan KASKEL, Dresden (DE); Michael KOHL, Dresden (DE)

(73) Assignee: FRAUNHOFER-GESELLSCHAFT ZUR FÖRDERUNG DER ANGEWANDTEN FORSCHUNG E.V., München (DE)

(21) Appl. No.: 15/570,818

(22) PCT Filed: Apr. 27, 2016
(86) PCT No.: PCT/EP2016/059397

§ 371 Date: Oct. 31, 2017

(30) Foreign Application Priority Data
May 4, 2015 (DE) 10 2015 208 197.4

(51) Int. Cl. H01M 10/0525; H01M 10/0569; H01M 10/054; H01M 4/58; H01M 10/0563; H01M 4/02

(52) U.S. Cl. CPC H01M 10/0525; H01M 10/0569; H01M 10/054; H01M 2300/0034; H01M 10/0563; H01M 2004/028; H01M 4/5825

(57) ABSTRACT

According to the invention, an electrolyte is provided for an alkali-sulfur battery. An alkali-sulfur battery is also provided, which contains the electrolyte according to the invention. The electrolyte according to the invention contains a mixture of a sulfone and a fluorine-containing ether in a volume ratio of #1:4 (v:v). Through the use of said electrolyte, the shuttling of polysulfide species from the cathode to the anode can be effectively suppressed, without the use of LiNO₃. Through the electrolyte in alkalisulfur batteries, a high coulombic efficiency, long-term stability (low self-discharge) and cycle durability can be achieved even without the use of LiNO₃. Coloumbic efficiency, long-term stability and cycle durability can be further improved through the use of a cathode which contains an additive for uniform distribution of polysulfide inside the cathode. In addition, uses of components of the alkali-sulfur battery according to the invention are also disclosed.

According to the invention, an electrolyte for an alkali-sulfur battery is provided. In addition, an alkali-sulfur battery which comprises the electrolyte according to the invention is presented. The electrolyte according to the invention comprises a mixture of a sulphone and a fluorine-containing ether in a volume ratio of ≥1:4 (v:v). By using this electrolyte, the shuttling of polysulphide species from the cathode to the anode can be effectively suppressed even without the use of LiNO₃. Even without the use of LiNO₃, a high coulomb efficiency, long-term stability (low self-discharge) and cyclability is achieved by the electrolyte in alkali-sulfur batteries. Coulomb efficiency, long-term stability and cyclability could also be improved further by the use of a cathode which comprises an additive for homogenised distribution of polysulphide within the cathode. In addition, uses of components of the alkali-sulfur battery according to the invention are proposed.

In lithium-sulfur batteries, occurs formation of so-called lithium-polysulphides (Li₂Sₙ, 2≤n≤8). Some of these polysulphide species are soluble in the commonly used electrolytes (e.g. a mixture of DME:DOL with a conductive salt). The dissolved polysulphides can penetrate the separator and are reduced to form lower polysulphide species on the anode. During the charging process, reoxidation on the cathode follows the reduction, as a result of which a circulation process which significantly reduces the coulomb efficiency of the accumulator results. If the battery is stored in the charged state, the result can likewise be formation of soluble polysulphides which are reduced on the anode. As a result, the capacity of the cell is reduced. Furthermore, the cyclability is reduced due to irreversible processes associated with these processes.

It is known in the state of the art that the addition of N—O-containing compounds (such as e.g. LiNO₃) leads to a substantially improved coulomb efficiency and cyclability. This mechanism begins on the lithium anode. It is assumed that, as a result of the nitrate compounds, the result is formation of sulphitic species on the surface of the lithium anode.

The addition of LiNO₃ or other N—O-containing compounds does not however solve the problem comprehensively. Firstly, degradation of the anode cannot be completely prevented by the presence of LiNO₃. In addition, the protective effect on the anode side decreases continuously, since continual repair processes on the surface film of the anode consume LiNO₃ and also active material in the form of polysulphide species. Consequently, this has a negative effect on the cyclability of the cell. Furthermore, LiNO₃ influences the chemistry of the cell negatively as a result of subsidiary reactions. Hence the requirement exists in the state of the art for solutions which are successful without the use of LiNO₃.

Polyethylene oxide-based polymer electrolytes have been used successfully already as cathode supplement or as membrane in lithium-sulfur batteries but cannot, per se, completely suppress the polysulphide shuttle.

Fluorine-containing ethers (in particular TTE or HFE) have been used in the past as electrolyte additive, these being distinguished by low solubility for polysulphides. However complete suppression of the polysulphide shuttle could not be achieved even with fluorine-containing ethers as electrolyte additive. In an attempt at improvement, LiNO₃ was added to the electrolyte, which led however to the occurrence of high excess potentials which imply kinetic restriction of the polysulphide conversion.

A further disadvantage is that only low use of the active material (<70%) is possible.

Starting herefrom, it was the object of the present invention to provide an electrolyte for an alkali-sulfur battery which, even without use of LiNO₃, effects improved suppression of the polysulphide shuttle and hence ensures high coulomb efficiency, long-term stability (low self-discharge) and cyclability in alkali-sulfur batteries.

The object is achieved by the electrolyte according to claim 1, the alkali-sulfur battery according to claim 8, the uses according to claims 19 and 20. The dependent claims represent preferred embodiments of the invention.

According to the invention, an electrolyte for an alkali-sulfur battery is provided, the electrolyte comprising a sulphone and a fluorine-containing ether or consisting thereof and being characterised in that the volume ratio of the sulphone to the fluorine-containing ether is ≥1:4 (v:v). The electrolyte according to the invention comprises a sulphone, which effects particularly high oxidation stability. In addition, the electrolyte has increased reliability relative to inflammability and hence permits the use in alkali-sulfur batteries over a wide temperature range. Furthermore, the electrolyte effects a high coulomb efficiency, long-term stability (low self-discharge) and cyclability in alkali-sulfur batteries.

In the electrolyte according to the invention, the volume ratio of the sulphone to the fluorine-containing ether is preferably ≥1:3 (v:v), particularly preferably 1:3 (v:v) to 1:1 (v:v).

The electrolyte can be liquid, gel-like or solid, preferably liquid or gel-like, particularly preferably liquid. The indicated aggregate states relate to room temperature (25° C.).

The fluorine-containing ether can be selected from the group consisting of 2,2,2-trifluoroethylmethylether, 2,2,2-trifluoroethyldifluoromethylether, 2,2,3,3,3-pentafluoropropylmethylether, 2,2,3,3,3-pentafluoropropyldifluoromethylether, 2,2,3,3,3-pentafluoropropyl-1,1,2,2-tetrafluoroethylether, 1,1,2,2-tetrafluoroethylmethylether, 1,1,2,2-tetrafluoroethylethylether, 1,1,2,2-tetrafluoroethylpropylether, 1,1,2,2-tetrafluoroethylbutylether, 1,1,2,2-tetrafluoroethylisobutylether, 1,1,2,2-tetrafluoroethylisopentylether, 1,1,2,2-tetrafluoroethyl-2,2,2-trifluoroethylether, 1,1,2,2-tetrafluoroethyl-2,2,3,3-tetrafluoropropylether, hexafluoroisopropylmethylether, 1,1,3,3,3-pentafluoro-2-trifluoromethylpropylmethylether, 1,1,2,3,3,3-hexafluoropropylmethylether, 1,1,2,3,3,3-hexafluoropropylethylether, and 2,2,3,4,4,4-hexafluorobutyldifluoromethylether, preferably 1,1,2,2-tetrafluoroethylpropylether, particularly preferably 1,1,2,2-tetrafluoroethyl-2,2,3,3-tetrafluoropropylether.

The sulphone can be selected from the group consisting of non-cyclic aliphatic sulphones (preferably ethylmethylsulphone, ethylvinylsuphone and/or butylsulphone) and cyclic aliphatic sulphones (preferably tetramethylene sulphone). Optionally, the sulphone is a fluorinated sulphone or not a fluorinated sulphone. Non-fluorine-containing sulphones, such as e.g. sulpholane, have a positive effect both on the cathode chemistry and on the anode surface since they have particularly high oxidation stability and also good compatibility with lithium.

The electrolyte can comprise a salt which is selected from the group consisting of LiPF₆, LiBF₄, LiClO₄, LiSO₃CF₃, LiN(SO₂F)₂, LiN(SO₂CF₃)₂, LiN(SO₂F)(SO₂CF₃), LiN(SO₂F)(SO₂C₄F₉), LiN(SO₂CF₂CF₃)₂, LiC(SO₂CF₂CF₃)₃, LiC(SO₂CF₃)₃, LiI, LiCl, LiF, LiPF₅(SO₂CF₃), LiPF₄(SO₂CF₃)₂, and mixtures hereof, preferably LiN(SO₂CF₃)₂. The salt is preferably contained in a concentration of >0 mol/l to 2.5 mol/l.

In a further preferred embodiment, the electrolyte comprises no LiNO₃.

Furthermore, an alkali-sulfur battery is provided according to the invention, comprising
a) an electrolyte according to the invention;
b) a cathode, which comprises
   i) carbon;
   ii) a sulfur-containing cathode active material which is selected from the group consisting of elementary sulfur, inorganic sulfur compound (optionally oligomeric or polymeric), organic sulfur compound (optionally oligomeric or polymeric), alkali metal sulphide (preferably lithium sulphide or sodium sulphide), alkali metal oligosulphide (preferably lithium oligosulphide or sodium oligosulphide), alkali metal polysulphide (preferably lithium polysulphide or sodium polysulphide); and
   iii) optionally an additive for homogenised distribution of polysulphide within the cathode;
   or consists thereof;
c) an anode which comprises an anode active material or consists thereof, which is selected from the group consisting of alkali metal, alkali metal-carbon intercalate, metal powder, a compound which is suitable for reversible oxidation and reduction with an alkali metal ion, and mixtures or alloys hereof (e.g. an alloy with Si and/or Sn), preferably lithium, sodium, lithium-graphite intercalate, sodium-graphite intercalate, and mixtures or alloys hereof;
d) a separator;

or consisting thereof.

The alkali-sulfur battery is distinguished by high coulomb efficiency, long-term stability (low self-discharge) and cyclability.

The alkali-sulfur battery can be characterised in that the cathode comprises 40 to 80% by weight, preferably 50 to 70% by weight, particularly preferably 55 to 65% by weight, of sulfur, relative to the total weight of the cathode. Furthermore, the cathode can comprise 20 to 50% by weight, preferably 25 to 45% by weight, particularly preferably 30 to 40% by weight, of carbon, relative to the total weight of the cathode.

In addition, the cathode can comprise 1 to 30% by weight, preferably 2 to 20% by weight, particularly preferably 2.5 to 15% by weight, of additive for homogenised distribution of polysulphide within the cathode, relative to the total weight of the cathode. Because of the low solubility of polysulphides in the electrolyte according to the invention, the reactivity thereof in the cathode is generally low. The additive increases locally, in the cathode, the solubility and distribution of polysulphides and alkali sulphides (e.g. Li₂S) and hence ensures high reactivity of polysulphides and the reversibility of conversion thereof during battery operation. It is advantageous if the additive is contained only in the cathode of the alkali-sulfur battery, i.e. not in the separator and electrolyte. If the additive were present e.g. also in the separator or distributed homogeneously in the electrolyte, the polysulphide shuttling would be assisted and the coulomb efficiency would be impaired. Local limitation of the additive to the cathode can be achieved for example by the additive being present as a gel or being bonded chemically covalently to the cathode.

The additive for homogenised distribution of polysulphide can comprise a redox mediator for alkali polysulphide, preferably a redox mediator for lithium polysulphide, particularly preferably a metal oxide as redox mediator for lithium polysulphide, in particular manganese oxide, aluminium oxide and/or titanium oxide, or can consist thereof.

Furthermore, the additive for homogenised distribution of polysulphide can comprise a polymer, which polymer comprises oxygen atoms, nitrogen atoms and/or halogen atoms or consist thereof, preferably a polymer which comprises the ether functionality —(CH₂—CH₂—O—)ₙ with n 1, particularly preferably polyethylene oxide. This polymer (e.g. PEO) has the effect that (short-chain) polysulphide species are brought or kept in solution in situ on the cathode side and hence a locally increased stabilisation and conversion of these polysulphide species takes place without these being able to move from the cathode side to the anode side. Therefore good kinetics for the conversion of active material is achieved, the shuttle mechanism being effectively suppressed even without use of LiNO₃. The anode is therefore not contacted by polysulphide species but merely by the (e.g. liquid) electrolyte, the degradation products of which form a stable, insoluble surface film. Furthermore, it was observed that, by means of the polymer, a significantly higher active material use of almost 90% is possible (without the polymer only approx. 70%) and a surprisingly long discharge plateau between 1.8-2.0 V occurs.

Preferably, the cathode comprises a gel or consists thereof. The gel state of the cathode can occur for example by the cathode comprising a specific concentration of the above-mentioned polymer (e.g. PEO). Insoluble cathode components (e.g. carbon and/or sulfur) are preferably wetted by the above-mentioned polymer.

The cathode can comprise a binder, the binder being selected preferably from the group consisting of styrene-butadiene rubber, polytetrafluoroethylene, gelatines, polyacrylic acid, carboxymethyl cellulose, polyvinylpyrrolidone and polyvinylidene fluoride, particularly preferably styrene-butadiene rubber and polytetrafluoroethylene. The binder can be contained in a concentration of 1 to 10% by weight, preferably 1.5 to 8% by weight, particularly preferably 2 to 6% by weight, relative to the total weight of the cathode.

Preferably, the cathode comprises amorphous carbon, carbon nanotubes and/or carbon nanofibres, the amorphous carbon being particularly preferably carbon black. Furthermore, the cathode can comprise amorphous carbon and carbon nanofibres, the weight ratio of amorphous carbon to carbon nanofibres being preferably from 5:1 (w:w) to 20:1 (w:w), preferably from 8:1 (w:w) to 16:1 (w:w), particularly preferably from 10:1 (w:w) to 12:1 (w:w).

The amorphous carbon preferably has pores, particularly preferably micropores and mesopores, in particular micropores with a diameter of >0 to 2 nm and mesopores with a diameter of 2 to 50 nm.

In a preferred embodiment, the sulfur-containing cathode active material is distributed homogeneously in the carbon of the cathode. Preferably, the sulfur-containing cathode active material is present in pores of the carbon, particularly preferably in pores of the amorphous carbon, the cathode active material being present in particular melted in the pores.

In a preferred embodiment, the cathode comprises an inorganic solid which does not concern sulfur, preferably a redox mediator for alkali polysulphide, particularly a redox mediator for lithium polysulphide, in particular manganese dioxide, aluminium oxide and/or titanium oxide (optionally in so-called nanosheets).

The separator can comprise polypropylene or consist thereof.

The use of a composition comprising or consisting of a fluorine-containing ether and a sulphone, preferably 1,1,2,2-tetrafluoroethyl-2,2,3,3-tetrafluoropropylether and tetramethylene sulphone (sulpholane), as electrolyte in alkali-sulfur batteries, preferably lithium-sulfur batteries, is proposed.

Furthermore the use of a composition comprising or consisting of polyethylene oxide, preferably polyethylene oxide and styrene-butadiene rubber, particularly preferably polyethylene oxide, styrene-butadiene rubber and polyvinylpyrrolidone, as binder for cathodes in alkali-sulfur batteries, preferably lithium-sulfur batteries, is proposed.

The subject according to the invention is intended to be explained in more detail with reference to the subsequent Figures and examples without wishing to restrict said subject to the specific embodiments represented here.

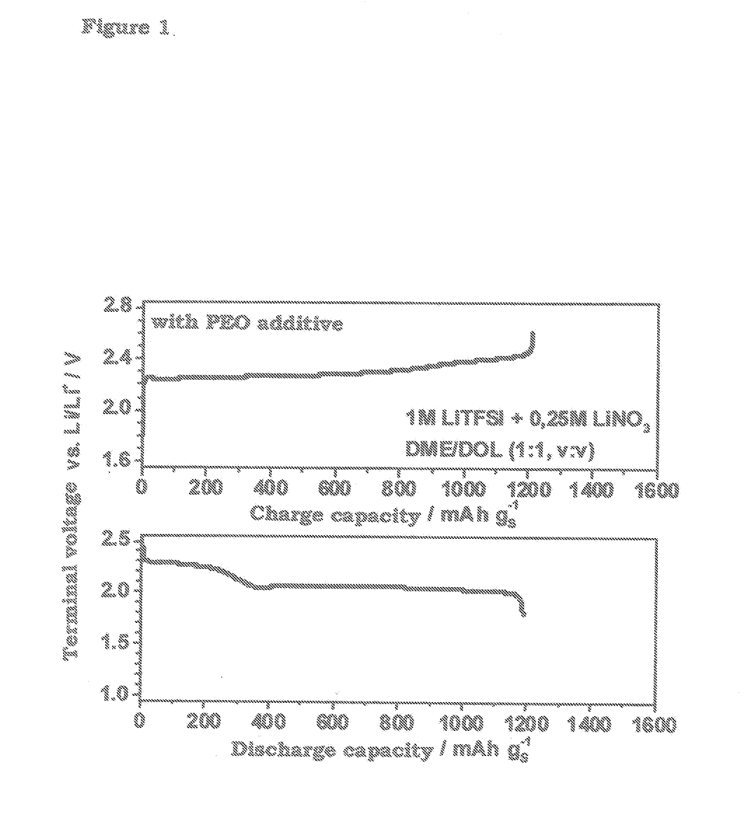

FIG. 1 shows a galvanostatic measurement of the charge capacity and discharge capacity of a lithium-sulfur battery with PEO as (cathode) additive which was operated with an electrolyte comprising DME and DOL (1:1, v:v) and also LiNO₃. The cycling (charge/discharge) was effected at a rate of C/10 between 1.8-2.6 V vs. Li/Li⁺.

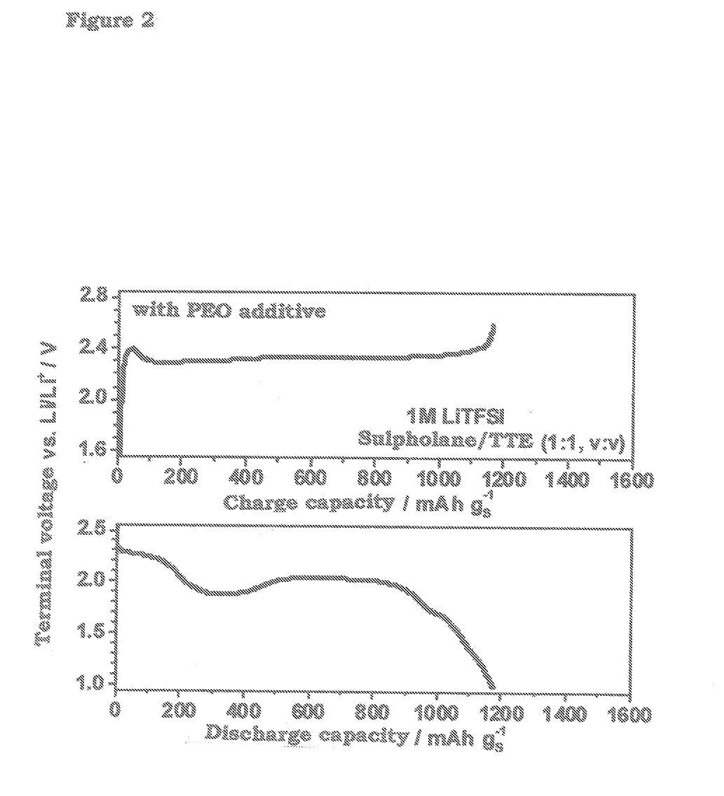

FIG. 2 shows a galvanostatic measurement of the charge capacity and discharge capacity of a lithium-sulfur battery with PEO as (cathode) additive which was operated with an electrolyte comprising sulpholane and TTE (1:1, v:v). After a forming cycle between 1.0-2.6 V vs. Li/Li⁺, the cycling (charge/discharge) was effected between 1.5-2.6 V vs. Li/Li⁺. The rate was respectively C/10.

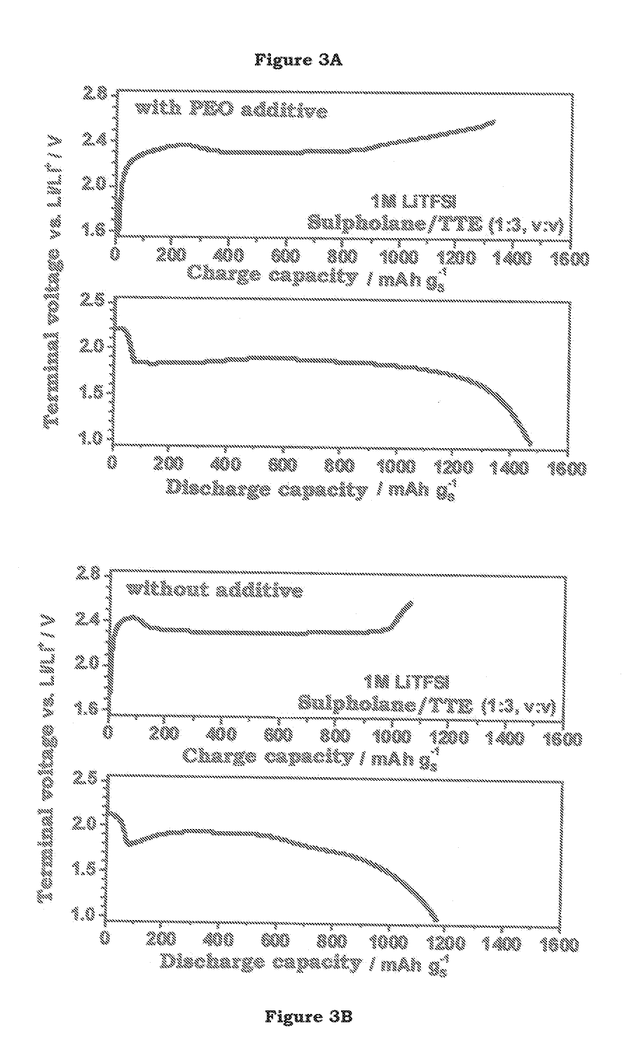

FIGS. 3A and 3B show respectively a galvanostatic measurement of the charge capacity and discharge capacity of a lithium-sulfur battery which was operated with an electrolyte comprising sulpholane and TTE (1:3, v:v). After a forming cycle between 1.0-2.6 V vs. Li/Li⁺ the cycling (charge/discharge) was effected between 1.5-2.6 V vs. Li/Li⁺. The rate was respectively C/10. In FIG. 3A the result which was obtained during use with PEO as additive in the cathode is illustrated, whereas FIG. 3B illustrates the result which was obtained during use of a cathode without additive.

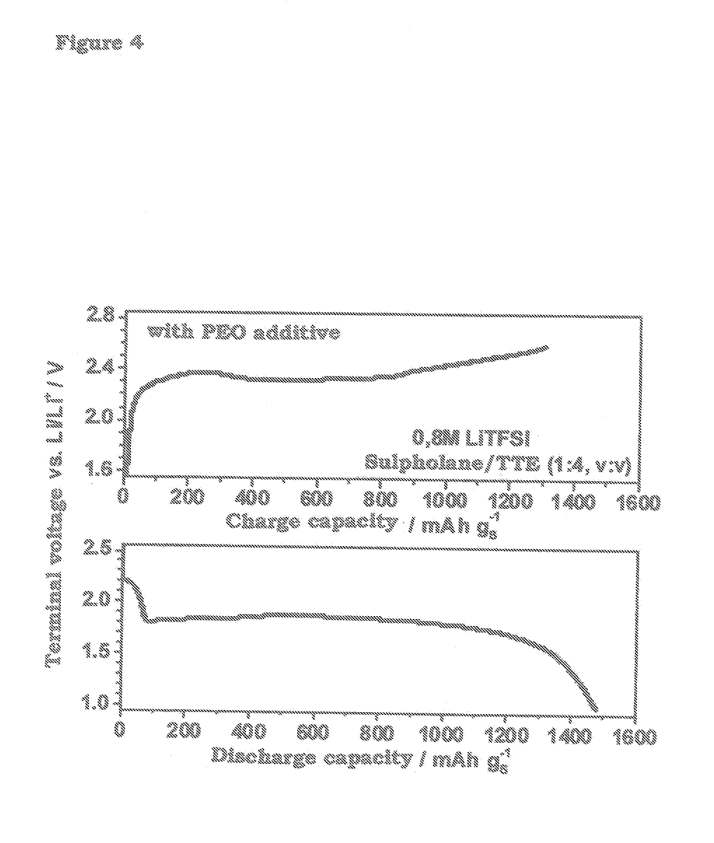

FIG. 4 shows a galvanostatic measurement of the charge capacity and discharge capacity of a lithium-sulfur battery with PEO as (cathode) additive which was operated with an electrolyte comprising sulpholane and TTE (1:4, v:v). After a forming cycle between 1.0-2.6 V vs. Li/Li⁺ the cycling (charge/discharge) was effected between 1.5-2.6 V vs. Li/Li⁺. The rate was respectively C/10.

### EXAMPLE 1—PRODUCTION OF AN ALKALI-SULFUR BATTERY ACCORDING TO THE INVENTION

An alkali-sulfur battery according to the invention can be produced by a method which comprises the following steps
a) melting of sulfur and amorphous carbon to form a first composite;
b) grinding of the first composite with carbon nanotubes to form a second composite;
c) mixing-in of a slurry made of the second composite, binder and water;
d) grinding of the slurry;
e) knife-coating of the ground slurry to form layers;
f) drying of the layers,
g) calendering of the layers (advantage: more compact and smoother layer with high density and good electronic and mechanical bonding);
h) arrangement of the calendered layers on a first side of a separator;
i) arrangement of an anode which comprises an alkali metal or consists thereof on a second side of the separator; and
j) addition of an electrolyte which comprises a fluorine-containing ether and a sulphone or consists thereof.

In the method, step a) can be implemented at a temperature of 100 to 200° C., preferably 130 to 170° C., for 10 minutes to 60 minutes, preferably 20 minutes to 40 minutes. In step b) and/or step d), grinding takes place in an oscillating mill. In step f), firstly drying takes place at 20 to 30° C. and subsequently the layers are heated for 1 to 2 hours at 80° C.

### EXAMPLE 2—PRODUCTION OF A CATHODE COMPRISING PEO ADDITIVE AND OF A LITHIUM-SULFUR BATTERY WITH THIS CATHODE AND A REFERENCE ELECTROLYTE

For production of the cathode, firstly a KB/S composite (8:15, m:m) is produced by melting of carbon black (Ketjen black EC600-JD=KB) and sulfur (S) in a drying cabinet at 155° C. for 12 h.

Subsequently, mixing-in of a slurry made of
1.84 g of KB/S (total content: 92% by weight);
0.06 g of carbon nanofibers (CNF) (total content: 3% by weight); and
0.1 g of a mixture of polyethylene oxide (PEO) additive, polyvinylpyrrolidone (PVP) and styrene-butadiene rubber (SBR) (PEO:PVP:SBR=2.8:0.7:1.5; m:m:m) as binder (total binder content: 5% by weight).

The binder was hereby used as 4% (% by weight) solution in H₂O, after which KB/S composite+CNF was ground at 25 Hz for 10 min in an oscillating mill (Retsch MM400). Furthermore, also 5 ml H₂O was added to the slurry. Subsequently, a second grinding process followed at 25 Hz for 30 min.

A layer is knife-coated, which layer is dried overnight at room temperature and subsequently at 80° C. for 1.5 h in air and subsequently calendered. The sulfur loading of the layer (active layer) was approx. 1.4 mg sulfur/cm² and the density thereof approx. 0.7 g/cm³ and can be used as cathode in alkali-sulfur batteries.

The cathode obtained by the above-mentioned method was subsequently built up in a button cell (CR2016). The components were:
12 mm knife-coated active layer as cathode (see above);
1 separator (Celgard 3500, 19 mm diameter);
250 μm lithium foil as anode (MTI Corp., 15.6 mm diameter);
2×500 μm V2A steel spacer (15.4 mm diameter).

In the button cell, an electrolyte was used, which comprises 1 M LiTFSI (Aldrich, 99.95%) and 0.25 M LiNO₃ (Alfa Aesar, 99.98%, water-free) in
50% by vol. of DME (Sigma Aldrich, 99.5%, water-free); and
50% by vol. of DOL (Aldrich, 99.8%, water-free);

(=reference electrolyte). The electrolyte-to-sulfur ratio was 8 μl electrolyte/mg sulfur.

The cell was subsequently measured galvanostatically, the cycling (charge/discharge being effected at a rate of C/10 between 1.8-2.6 V vs. Li/Li⁺. The result is illustrated in FIG. 1.

### EXAMPLE 3—LITHIUM-SULFUR BATTERY WITH CATHODE COMPRISING PEO-ADDITIVE AND ELECTROLYTE ACCORDING TO THE INVENTION (SULPHOLANE:TTE=1:1, V:V)

The cathode comprising PEO-additive of Example 2 was built up in the same button cell as in Example 2.

In the button cell, an electrolyte was however used, which comprises 1 M LiTFSI (Aldrich, 99.95%) in
50% by vol. of sulpholane (Sigma Aldrich, 99%); and
50% by vol. of TTE (SynQuest Laboratories, Inc., 99%).

The electrolyte-to-sulfur ratio was 8 μl electrolyte/mg sulfur.

The cell was subsequently measured galvanostatically, the cycling (charge/discharge) being effected at a rate of C/10 between 1.5-2.6 V vs. Li/Li⁺. In the 1^{st} cycle for forming the cell, the discharge was effected at a rate of C/10 up to 1.0 V vs. Li/Li⁺. The result is illustrated in FIG. 2.

### EXAMPLE 4—LITHIUM-SULFUR BATTERY WITH CATHODE COMPRISING PEO-ADDITIVE AND FURTHER ELECTROLYTE ACCORDING TO THE INVENTION (SULPHOLANE:TTE=1:3, V:V)

The cathode comprising PEO-additive of Example 2 was built up in the same button cell as in Example 2.

As electrolyte of the button cell, an electrolyte was however used, which comprises 1 M LiTFSI (Aldrich, 99.95%) in
25% by vol. of sulpholane (Sigma Aldrich, 99%); and
75% by vol. of TTE (SynQuest Laboratories, Inc., 99%).

The electrolyte-to-sulfur ratio was 8 μl electrolyte/mg sulfur.

The cell was subsequently measured galvanostatically, the cycling (charge/discharge) being effected at a rate of C/10 between 1.5-2.6 V vs. Li/Li⁺. In the 1^{st} cycle for forming the cell, the discharge was effected at a rate of C/10 to 1.0 V vs. Li/Li⁺. The result is illustrated in FIG. 3A.

### EXAMPLE 5—LITHIUM-SULFUR BATTERY WITH CATHODE COMPRISING PEO-ADDITIVE AND FURTHER ELECTROLYTE ACCORDING TO THE INVENTION (SULPHOLANE:TTE=1:4, V:V)

The cathode comprising PEO-additive of Example 2 was built up in the same button cell as in Example 2.

As electrolyte of the button cell, an electrolyte was however used, which comprises 0.8 M LiTFSI (Aldrich, 99.95%) in
20% by vol. of sulpholane (Sigma Aldrich, 99%); and
80% by vol. of TTE (SynQuest Laboratories, Inc., 99%);

The electrolyte-to-sulfur ratio was 8 μl electrolyte/mg sulfur.

The cell was subsequently measured galvanostatically, the cycling (charge/discharge) being effected at a rate of C/10 between 1.5-2.6 V vs. Li/Li⁺. In the 1^{st} cycle for forming the cell, the discharge was effected at a rate of C/10 to 1.0 V vs. Li/Li⁺. The result is illustrated in FIG. 4.

### EXAMPLE 6—LITHIUM-SULFUR BATTERY WITH CATHODE WITHOUT ADDITIVE AND ELECTROLYTE ACCORDING TO THE INVENTION (SULPHOLANE:TTE=1:3, V:V)

Firstly, a KB/S composite (1:2, m:m) was produced by melting of carbon black (Ketjen black EC600-JD=KB) and sulfur (S) in a drying cabinet at 155° C. for 12 h.

Subsequently, KB/S (97%) was ground with PTFE binder (3%) at increased temperature and pressed dry by a rolling process to form a cathode film.

Subsequently, lamination was effected on carbon-primed aluminium foil. The sulfur loading of the active layer was approx. 2.2 mg sulfur/cm² and the density thereof approx. 0.6 g/cm³.

The obtained cathode without additive was built up in the same button cell as in Example 2.

As electrolyte of the button cell, an electrolyte was however used, which comprises 1.0 M LiTFSI (Aldrich, 99.95%) in
25% by vol. of sulpholane (Sigma Aldrich, 99%); and
75% by vol. of TTE (SynQuest Laboratories, Inc., 99%).

The electrolyte-to-sulfur ratio was 8 μl electrolyte/mg sulfur.

The cell was subsequently measured galvanostatically, the cycling (charge/discharge) being effected at a rate of C/10 between 1.5-2.6 V vs. Li/Li⁺. In the 1^{st} cycle for forming the cell, the discharge was effected at a rate of C/10 up to 1.0 V vs. Li/Li⁺. The result is illustrated in FIG. 3B.

1-20. (canceled)

21. An electrolyte for an alkali-sulfur battery, the electrolyte comprising a sulphone and a fluorine-containing ether, wherein the volume ratio of the sulphone to the fluorine-containing ether is >1:4 (v:v).

22. The electrolyte according to claim 21, wherein the volume ratio of the sulphone to the fluorine-containing ether is ≥1:3 (v:v).

23. The electrolyte according to claim 21, wherein the electrolyte is a liquid, a gel, or a solid.

24. The electrolyte according to claim 21, wherein the fluorine-containing ether is selected from the group consisting of 2,2,2-trifluoroethylmethylether, 2,2,2-trifluoroethyldifluoromethylether, 2,2,3,3,3-pentafluoropropylmethylether, 2,2,3,3,3-pentafluoropropyldifluoromethylether, 2,2,3,3,3-pentafluoropropyl-1,1,2,2-tetrafluoroethylether, 1,1,2,2-tetrafluoroethylmethylether, 1,1,2,2-tetrafluoroethylethylether, 1,1,2,2-tetrafluoroethylpropylether, 1,1,2,2-tetrafluoroethylbutylether, 1,1,2,2-tetrafluoroethylisobutylether, 1,1,2,2-tetrafluoroethylisopentylether, 1,1,2,2-tetrafluoroethyl-2,2,2-trifluoroethylether, 1,1,2,2-tetrafluoroethyl-2,2,3,3-tetrafluoropropylether, hexafluoroisopropylmethylether, 1,1,3,3,3-pentafluoro-2-trifluoromethylpropylmethylether, 1,1,2,3,3,3-hexafluoropropylmethylether, 1,1,2,3,3,3-hexafluoropropylethylether, and 2,2,3,4,4,4-hexafluorobutyldifluoromethylether.

25. The electrolyte according to claim 21, wherein the sulphone is selected from the group consisting of cyclic aliphatic sulphones and non-cyclic aliphatic sulphones.

26. The electrolyte according to claim 21, wherein the electrolyte is a salt selected from the group consisting of LiPF₆, LiBF₄, LiClO₄, LiSO₃CF₃, LiN(SO₂F)₂, LiN(SO₂CF₃)₂, LiN(SO₂F)(SO₂CF₃), LiN(SO₂F)(SO₂C₄F₉), LiN(SO₂CF₂CF₃)₂, LiC(SO₂CF₂CF₃)₃, LiC(SO₂CF₃)₃, LiI, LiCl, LiF, LiPF₅(SO₂CF₃), LiPF₄(SO₂CF₃)₂, and mixtures thereof, wherein the salt is contained in a concentration of more than 0 mol/l and up to at most 2.5 mol/l.

27. The electrolyte according to claim 21, wherein the electrolyte comprises no LiNO₃.

28. An alkali-sulfur battery comprising
a) the electrolyte according to claim 21;
b) a cathode, which comprises
i) carbon;
ii) a sulfur-containing cathode active material selected from the group consisting of elementary sulfur, inorganic sulfur compound, organic sulfur compound, alkali metal sulphide, alkali metal oligosulphide, alkali metal polysulphide, and mixtures thereof; and optionally
iii) an additive for producing homogeneous distribution of polysulphide within the cathode;
c) an anode which comprises an anode active material selected from the group consisting of alkali metal, alkali metal-carbon intercalate, metal powder, and a compound which is suitable for reversible oxidation and reduction with an alkali metal ion; and
d) a separator.

29. The alkali-sulfur battery according to claim 28, wherein the cathode comprises
i) 20 to 50% by weight of carbon; and/or
ii) 40 to 80% by weight of sulfur; and/or
iii) 1 to 30% by weight of the additive;
relative to the total weight of the cathode.

30. The alkali-sulfur battery according to claim 28, wherein the additive comprises a redox mediator for alkali polysulphide.

31. The alkali-sulfur battery according to claim 28, wherein the additive comprises a polymer which comprises oxygen atoms, nitrogen atoms and/or halogen atoms, or a polymer which comprises an ether functionality of —(CH₂—CH₂—O—)ₙ with n≥1.

32. The alkali-sulfur battery according to claim 28, wherein the cathode comprises a binder selected from the group consisting of styrene-butadiene rubber, polytetrafluoroethylene, gelatines, polyacrylic acid, carboxymethyl cellulose, polyvinylpyrrolidone, and polyvinylidene fluoride.

33. The alkali-sulfur battery according to claim 28, wherein the cathode comprises a binder in a concentration of 1 to 10% by weight relative to the total weight of the cathode.

34. The alkali-sulfur battery according to claim 28, wherein the cathode comprises amorphous carbon, carbon nanotubes, and/or carbon nanofibres, the amorphous carbon being carbon black.

35. The alkali-sulfur battery according to claim 28, wherein the cathode comprises amorphous carbon and carbon nanofibres, the weight ratio of amorphous carbon to carbon nanofibres being from 5:1 (w:w) to 20:1 (w:w).

36. The alkali-sulfur battery according to claim 35, wherein the amorphous carbon has micropores with a diameter of >0 to 2 nm and mesopores with a diameter of 2 to 50 nm.

37. The alkali-sulfur battery according to claim 28, wherein the sulfur-containing cathode active material is distributed homogeneously in the carbon of the cathode.

38. The alkali-sulfur battery according to claim 28, wherein the separator comprises polypropylene.
